(19) United States
(12) Patent Application Publication
(10) Pub. No.: US 2017/0203468 A1
(43) Pub. Date: Jul. 20, 2017

(54) STRUCTURAL FORMATION SYSTEM

(71) Applicant: Caterpillar Inc., Peoria, IL (US)

(72) Inventors: John Sherman, Peoria, IL (US); Matthew T. West, East Peoria, IL (US); Sam M. Kherat, Peoria, IL (US)

(73) Assignee: Caterpillar Inc., Peoria, IL (US)

(21) Appl. No.: 14/996,289

(22) Filed: Jan. 15, 2016

(51) Int. Cl. B28B 1/00; B33Y 30/00; E04C 5/00; E04G 21/04; E04B 1/16

(52) U.S. Cl. CPC B28B 1/001; E04G 21/0436; E04G 21/0445; E04B 1/161; E04C 5/00; B33Y 30/00; E04B 2103/02

(57) ABSTRACT

A structural formation system includes a first component that is configured to deposit an unhardened first material for forming one or more layers of a three-dimensional structure. The structural formation system also includes a second component that is configured to at least partly incorporate a second material within the unhardened first material of the three-dimensional structure. Moreover, the first and second components of the structural formation system are independently operable for forming the three-dimensional structure integrally with the first and second materials.

### TECHNICAL FIELD

The present disclosure relates to a structural formation system. More particularly, the present disclosure relates to a structural formation system that is configured to incorporate at least two distinct materials when forming a three-dimensional structure.

### BACKGROUND

Contour crafting is a manufacturing process used to fabricate large-scale, three-dimensional structures in a layer-by-layer manner by extruding a flowable material for e.g., concrete. The flowable material is extruded through an extrusion tip carried by a print head, and deposited in a sequence of paths on a substrate in a plane. The extruded material fuses with previously deposited material, and solidifies over time and/or with decrease in temperature. The position of the print head relative to the substrate is then incremented along a height, perpendicular to the plane, and the process is then repeated to form the three-dimensional structure. The movement of the print head with respect to the substrate is performed under computer control, in accordance with preprogramed depositing paths. The depositing paths are obtained by initially slicing a digital representation of the three-dimensional structure into multiple horizontally sliced two-dimensional layers. Then, for each sliced two-dimensional layer, a path for depositing the flowable material is determined.

For reference, U.S. Pat. No. 8,518,308 discloses an apparatus for contour crafting. The apparatus includes a nozzle assembly configured to extrude material through an outlet; and a controllable robotic arm coupled to the nozzle assembly. At one end of the robotic arm, a gripper is provided. The gripper is configured to pick up an element and deposit the element at a desired position relative to the extruded material. The element may be one of: a reinforcement member for a structure being constructed; a segment of a plumbing pipe; an electric network component; and a tile.

However, numerous other requirements associated with contour crafting have necessitated the use of other types of equipment and implements to handle and deposit materials in a specific manner. Accordingly, manufacturers of various construction equipment have been undertaking efforts in developing systems that are directed towards improving a handling and/or incorporation of such materials when forming a required structure.

### SUMMARY OF THE DISCLOSURE

In an aspect of the present disclosure, a structural formation system includes a first component that is configured to deposit an unhardened first material for forming one or more layers of a three-dimensional structure. The structural formation system also includes a second component that is configured to at least partly incorporate a second material within the unhardened first material of the three-dimensional structure. Moreover, the first and second components of the structural formation system are independently operable for forming the three-dimensional structure integrally with the first and second materials.

In another aspect of the present disclosure, a concrete structure formation system includes a concrete deposition mechanism that is configured to lay down a first material required to form a three-dimensional structure. The concrete structure formation system further includes a reinforcement insertion mechanism that is configured to incorporate a second material at least partly within the first material as the first material is laid down. Moreover, the concrete deposition mechanism and the reinforcement insertion mechanism are independently operable for forming the three-dimensional structure integrally with the first and second materials.

In yet another aspect of the present disclosure, embodiments disclosed herein have also been directed to a machine having a frame that is configured to pivotally support the first component and the second component thereon. In an embodiment of this disclosure, the machine could be embodied in the form of an excavator.

Other features and aspects of this disclosure will be apparent from the following description and the accompanying drawings.

### BRIEF DESCRIPTION OF THE DRAWINGS

FIG. 1 is a side view of an exemplary machine, in which embodiments of the present disclosure can be implemented;

FIG. 2 is a diagrammatic illustration of a structural formation system that can be implemented in the machine of FIG. 1, in accordance with an embodiment of the present disclosure;

FIG. 3 is a diagrammatic illustration of the structural formation system, in accordance with another embodiment of the present disclosure; and

FIG. 4 is a diagrammatic illustration of a three-dimensional structure that can be formed using the structural formation system, in accordance with another embodiment of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

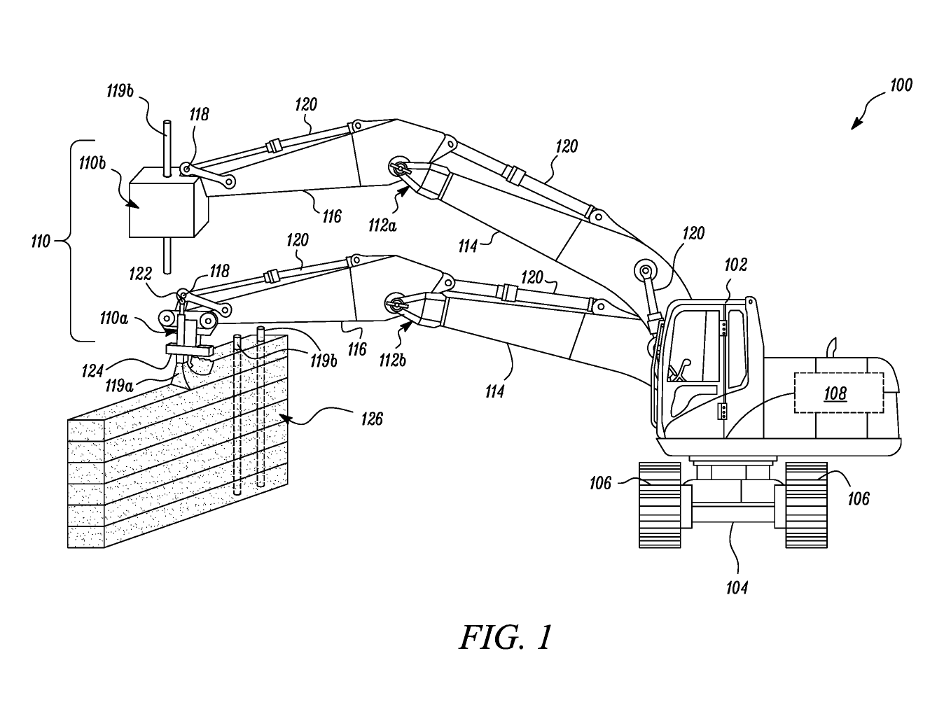

FIG. 1 illustrates a mobile machine 100 which may be used with the present disclosure. In an embodiment as shown in FIG. 1, the machine 100 is embodied in the form of an excavator. Although FIG. 1 illustrates an excavator, the present disclosure is applicable to other mobile machines besides an excavator and can include any machine where a work tool or other device may be attached to the machine with a pin joint. For example, the present disclosure may be similarly applied to backhoe loaders, wheel loaders, and other machines.

As depicted in FIG. 1, mobile machine 100 may include a body 102 disposed on top of and supported by a frame 104. Frame 104 may rotatably support thereon, one or more ground engaging devices 106, which may be used for mobility and propulsion of mobile machine 100. Ground engaging devices 106 are shown as a pair of continuous tracks; however, ground engaging devices 106 are not limited to being continuous tracks and may include other ground engaging devices such as rotatable wheels.

Mobile machine 100 may include a power system 108 providing power to move ground engaging devices 106 and may include one or more power sources, such as internal combustion engines, electric motors, fuel cells, batteries, ultra-capacitors, electric generators, and/or any power source which would be known by a person having ordinary skill in the art. Power system 108 may further be used to power various functions of a structural formation system 110 or any other elements and subsystems associated with the mobile machine 100 and/or structural formation system 110.

For positioning and control of structural formation system 110, mobile machine 100 may further include one or more linkage arrangements 112. For example, two linkage arrangements 112a and 112b are shown in the illustrated embodiment of FIG. 1. However, it should be noted that in other embodiments and/or depending on a specific machine type, fewer or more linkage arrangements could be included in the machine 100 for operatively positioning and controlling the structural formation system 110 disclosed herein.

Each linkage arrangement 112a and 112b may include a boom 114 operatively coupled with a stick 116. As shown, the structural formation system 110 may be attached to linkage arrangement 112a and/or 112b at, for example, a distal end 118 of the stick 116. Structural formation system 110 may be positioned and/or otherwise moved using a plurality of actuators. The term “actuator” refers to a component that is configured to selectively apply force against another component. The plurality of actuators may include, but are not limited to, hydraulic actuators, motors, or any other suitable device. The plurality of actuators may receive instructions to actuate a part of mobile machine 100, a part of structural formation system 110, or any other component associated with the structural formation system 110. In some embodiments, the plurality of actuators may be coupled to a pressurized oil system of mobile machine 100, and may be used to raise, lower, push, pull, rotate/pivot, or otherwise adjust the position of various components in the structural formation system 110 as will be described later herein.

The plurality of actuators on each linkage arrangement 112a and 112b (e.g., boom, stick, and tool actuators) may include a group of first actuators 120 and a group of second actuators 122. The group of second actuators 122 are capable of moving various components of structural formation system 110 independent of linkage arrangement 112. In one example, the group of second actuators 122 may include more than four prismatic actuators, such as, hydraulic cylinders. One example of the group of second actuators 122 that may be used consistent with the present disclosure is a Stewart platform. In a Stewart platform, the movement of structural formation system 110 may occur from a combination of synchronized motions of six hydraulic cylinders implemented on each of the linkage arrangements 112a and 112b.

The structural formation system 110 includes a first component 110a that is configured to deposit an unhardened first material 119a for forming one or more layers of a three-dimensional structure 126. As shown, the first component 110a may be located on the first linkage arrangement 112a. In embodiments disclosed herein, first material 119a could include a flowable cementitious mixture for e.g., concrete. As such, in various embodiments of this disclosure, the first component 110a may be embodied in the form of a concrete deposition mechanism. Accordingly, in such embodiments, the structural formation system 110 can be regarded as a concrete structure formation system.

Moreover, the concrete deposition mechanism may be regarded as an additive construction device for e.g., an extruder that includes at least one print head 124. Although one print head is shown in the illustrated embodiment of FIG. 1, fewer or more print heads could be included in the machine 100 depending on specific requirements of an application. The print head 124 is configured to deposit the flowable or unhardened first material 119a for constructing the structure 126 by laying down successive layers of the flowable first material 119a. Therefore, as typically known to one skilled in the art, the print head 124 would be configured to deposit the first material 119a in a layer-by-layer process. The term “structure” includes any part or whole of a building. An additive manufacturing process, also often referred to as contour crafting or three-dimensional printing, is a process of creating three-dimensional structures from a digital plan or design file. The digital plans and/or design files can be transformed into cross-sectional two-dimensional layers that are used to determine a manufacturing plan.

As shown, the structural formation system 110 further includes a second component 110b that is configured to at least partly incorporate a second material 119b within the unhardened first material 119a of the three-dimensional structure 126. As shown, the first component 110a could be located on the second linkage arrangement 112b. In various embodiments of this disclosure, the first and second components 110a and 110b are independently operable for forming the three-dimensional structure 126 integrally with the first and second materials 119a and 119b.

Consistent with the present disclosure, the construction of structure 126 may be executed according to a related manufacturing plan. The manufacturing plan may include instructions with defined depositing paths for successive layers of material to be laid and/or extruded until construction of structure 126 is completed. The defined depositing paths may be generated based on a digital, three-dimensional model. When extruding flowable material along a defined depositing path, the speed, position, and trajectory of the first component 110a can be controlled. Similarly, the manufacturing plan may further include instructions with defined paths for movement of the second component 110b when segments of the second material 119b 112b are to be incorporated until construction of structure 126 is completed. Therefore, when incorporating the second material 119b within the unhardened first material 119a along a defined incorporation path, the speed, position, and trajectory of the second component 110b can be controlled.

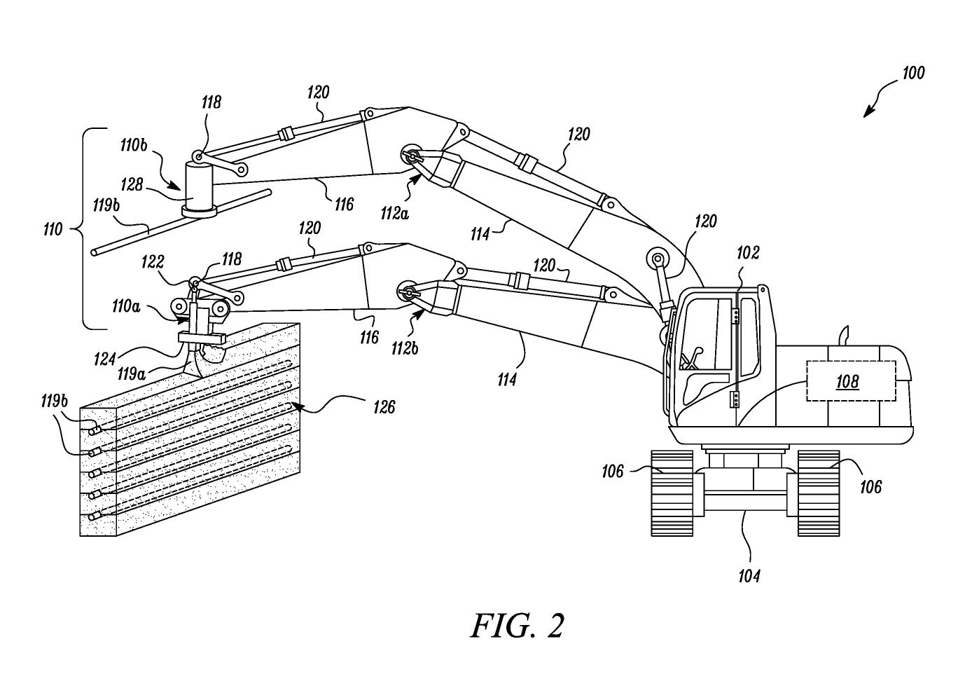

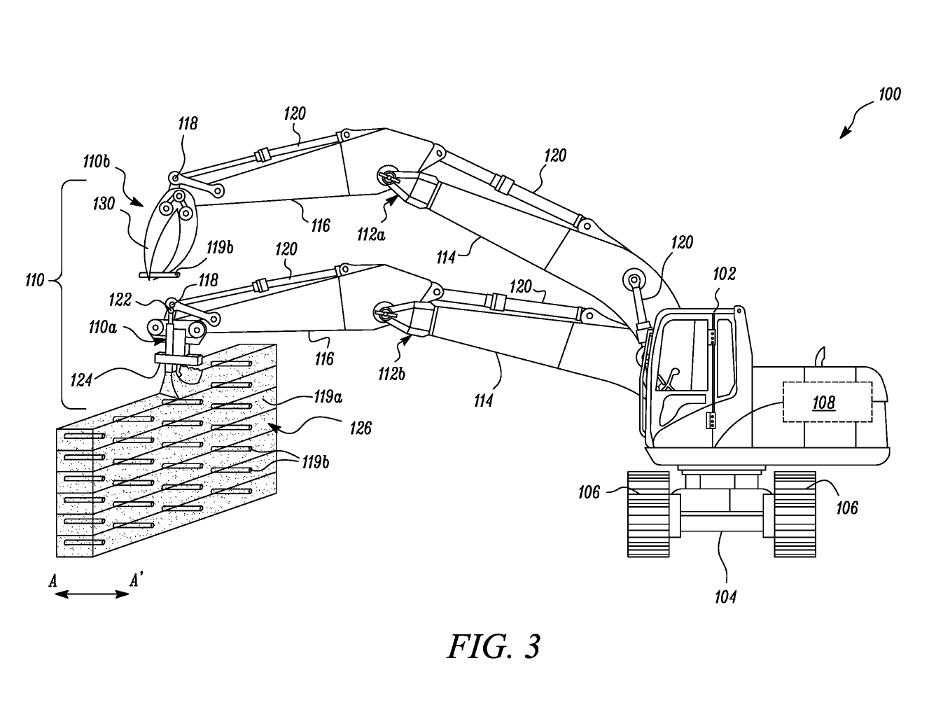

In various embodiments of the present disclosure, the second component 110b is a reinforcement insertion mechanism including at least one of: a magnetic end effector 128 (as shown in FIG. 2) and a grapple 130 (as shown in FIG. 3) configured to hold the second material 119b and incorporate such second material 119b at least partly within the unhardened first material 119a of the structure 126 as the first material 119a is being laid down. The magnetic end effector 128 from FIG. 2 may be used when the second material 119b is of a ferromagnetic nature for e.g., iron bars or iron rods and the like. The grapple 130 from FIG. 3 may be beneficially used when the second material 119b is non-magnetic in nature and/or bulky in volume. Although the magnetic end effector 128 and the grapple 130 are disclosed herein, it should be noted that other types of work implements such as, sprayers, forklift arrangements, buckets, telehandlers, hoppers, feeders, dispensers can be, additionally or optionally, contemplated to form part of the second component 110b depending on specific requirements of an application.

In an embodiment as shown in FIG. 2, the second material 119b includes elongated metal bars. However, in other embodiments, the second material 119b could include other materials such as, but not limited to, fabrics, fiberglass, or any combination thereof. In various embodiments of this disclosure, the second component 110b could be configured to position the second material 119b within the first material 119a in at least one of: vertical, horizontal, and lateral orientation with respect to the three-dimensional structure 126 to be formed. In an embodiment as shown in FIG. 1, the second component 110b is shown positioning the second material 119b vertically within the unhardened first material 119a of the structure 126. In another embodiment as shown in FIG. 2, the second component 110b is shown positioning the second material 119b horizontally within the unhardened first material 119a of the structure 126. Similarly, as shown in FIG. 3, the second component 110b could position the second material 119b laterally within the unhardened first material 119a of the structure 126. Such lateral positioning of the second material 119b is indicated with a direction arrow AA′ in FIG. 3.

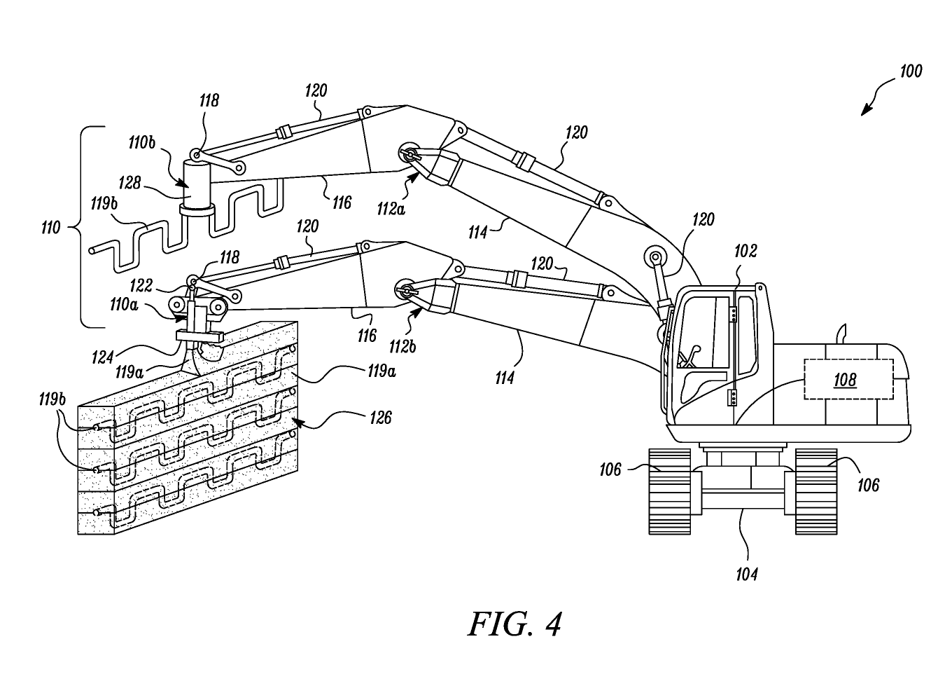

In another embodiment of this disclosure, the second component 110b could, also be configured to modulate a shape of the second material 119b prior to incorporating the second material 119b within the unhardened first material 119a. For example, as shown in FIG. 4, the second component 110b could be further configured to modulate a shape of the second material 119b into a square waveform. However, it may be noted that although a square waveform is illustrated in FIG. 4, any shape may be used in lieu of the square waveform. Some examples of such shapes may include tiered, zig-zag, circular, or elliptical, but is not limited thereto.

It is hereby contemplated that for accomplishing a modulation in the shape of the second material 119b, the second component 110b could include associated system hardware such as, but not limited to, material feeder systems, bar benders, wire extruders, and the like. Further, for incorporating individual segments of the second material 119b within the unhardened first material 119a, the second component 110b could additionally include system hardware such as, but not limited to, shearing mechanisms, cutters, blades, or other mechanisms typically known to one skilled in the art so that the continuously fed second material 119b may be cut into individual segments.

In an embodiment as shown in FIG. 2, the second component 110b may be configured to incorporate the second material 119b simultaneously with deposition of the unhardened first material 119a by the first component. However, in another embodiment as shown in FIG. 3, the second component 110b could be configured to incorporate the second material 119b after deposition of the unhardened first material 119a by the first component. For example, movement of the second component 110b may be delayed by an entire sequence or a mere phase-lag with respect to movement of the first component 110a so that incorporation of the second material 119b into the first material 119a follows deposition of the first material 119a by the first component 110. For example, incorporation of the second material 119b by the second component 110b could be one traverse behind the extrusion of each layer by the first component 110a.

Various embodiments disclosed herein are to be taken in the illustrative and explanatory sense, and should in no way be construed as limiting of the present disclosure. All joinder references (e.g., attached, affixed, associated, coupled, engaged, connected, locked, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

Embodiments of the present disclosure have applicability for use and implementation in contour crafting to produce three-dimensional structures. Moreover, embodiments of the present disclosure also have applicability in providing improved systems for incorporating additional materials into a base material when forming a structure.

As embodiments herein allow the incorporation of the second material as the first material is laid down, implementation of the disclosed embodiments can help construction personnel to produce structures quickly and with better strength as compared to previously known systems. Moreover, as the first component 110a and the second component 110b of the structural formation system 110 are co-located yet independently controllable in relation to one another, operators can beneficially vary the individual feed rates or deposition/incorporation rates of the first and second materials 119a and 119b when forming the structure 126.

Further, it may be noted that although the first and second components 110a and 110b of the structural formation system 110 are located on the independently movable linkage arrangements 112a and 112b, the first and second components 110a and 110b could be implemented as a single package mounted to a single linkage member of an articulating machine.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

What is claimed is:

1. A structural formation system comprising:
a first component configured to deposit an unhardened first material for forming one or more layers of a three-dimensional structure;
a second component configured to at least partly incorporate a second material within the unhardened first material of the three-dimensional structure; and
wherein the first and second components are independently operable for forming the three-dimensional structure integrally with the first and second materials.

2. The structural formation system of claim 1, wherein the first component is a concrete deposition mechanism including at least one print head configured to deposit the first material in a layer-by-layer process.

3. The structural formation system of claim 1, wherein the first material includes a flowable cementitious mixture.

4. The structural formation system of claim 1, wherein the second component is a reinforcement insertion mechanism including at least one of: a magnetic end effector and a grapple configured to hold the second material.

5. The structural formation system of claim 1, wherein the second material is a shape reinforcement member including at least one of: elongated metal bars, fabrics, fiberglass, and any combination thereof.

6. The structural formation system of claim 1, wherein the second material is positioned within the first material in at least one of: a vertical, a horizontal, and a lateral orientation with respect to the three-dimensional structure to be formed.

7. The structural formation system of claim 1, wherein the second component is further configured to modulate a shape of the second material prior to incorporating the second material within the first material.

8. The structural formation system of claim 1, wherein the second component is configured to incorporate the second material simultaneously with deposition of the unhardened first material by the first component.

9. The structural formation system of claim 1, wherein the second component is configured to incorporate the second material after deposition of the unhardened first material by the first component.

10. A concrete structure formation system comprising:
a concrete deposition mechanism configured to lay down a first material required to form a three-dimensional structure; and
a reinforcement insertion mechanism configured to incorporate a second material at least partly within the first material as the first material is laid down; wherein the concrete deposition mechanism and the reinforcement insertion mechanism are independently operable for forming the three-dimensional structure integrally with the first and second materials.

11. The concrete structure formation system of claim 10, wherein the concrete deposition mechanism includes at least one print head configured to lay down the first material in a layer-by-layer process.

12. The concrete structure formation system of claim 10, wherein the first material includes a cementitious mixture.

13. The concrete structure formation system of claim 10, wherein the second material is a shape reinforcement member including at least one of: elongated metal bars, fabrics, fiberglass, and any combination thereof.

14. The concrete structure formation system of claim 10, wherein the reinforcement insertion mechanism includes at least one of: a magnetic end effector and a grapple configured to hold the second material.

15. The concrete structure formation system of claim 10, wherein the second material is positioned within the first material in at least one of: a vertical, a horizontal, and a lateral direction with respect to the three-dimensional structure to be formed.

16. The concrete structure formation system of claim 10, wherein the second component is further configured to modulate a shape of the second material prior to incorporating the second material within the first material.

17. A machine comprising:
a frame configured to pivotally support:
a first component configured to deposit an unhardened first material for forming one or more layers of a three-dimensional structure; and
a second component configured to integrally incorporate a second material of the three-dimensional structure within the unhardened first material, wherein the first and second components are independently operable for forming the three-dimensional structure integrally with the first and second materials.

18. The machine of claim 17, wherein the first component includes at least one print head configured to deposit the first material in a layer-by-layer process.

19. The machine of claim 17, wherein the second component is a reinforcement insertion mechanism including at least one of: a magnetic end effector and a grapple configured to hold the second material.

20. The machine of claim 17, wherein the machine is an excavator.
